(19) United States
(12) Patent Application Publication
(10) Pub. No.: US 2012/0220286 A1
(43) Pub. Date: Aug. 30, 2012

(54) Periodic Channel Quality Indicator on Physical Uplink Control Channel for Carrier Aggregation

(75) Inventors: Runhua Chen, Dallas, TX (US); Anthony Ekpenyong, Farmers Branch, TX (US); Eko N. Onggosanusi, Allen, TX (US)

(73) Assignee: TEXAS INSTRUMENTS INCORPORATED, Dallas, TX (US)

(21) Appl. No.: 13/211,766

(22) Filed: Aug. 17, 2011

Related U.S. Application Data
(60) Provisional application No. 61/441,993, filed on Feb. 11, 2011.
(60) Provisional application No. 61/374,334, filed on Aug. 17, 2010.

(51) Int. Cl. H04W 24/10

(52) U.S. Cl. 455/422.1

(57) ABSTRACT

This application considers the need for enhancements to the baseline CSI reporting mechanisms including maximum payload size, CQI/PMI reporting configurations and CSI transmission in the event of collision between CSI reports from different CCs.

### TECHNICAL FIELD OF THE INVENTION

The technical field of this invention is wireless communication such as wireless telephony.

### BACKGROUND OF THE INVENTION

The 3GPP Release 10 specification introduced the carrier aggregation feature, wherein user equipment (UE) may be configured to simultaneously receive or transmit data on multiple component carriers (CCs). Each component carrier (CC) is also called a serving cell. The serving cell where the UE maintains a Radio Resource Control connection to the network is known as the primary cell or the primary component carrier. Additional component carriers can be configured for a UE for data transmission and reception, and these carriers are known as secondary component carriers or secondary serving cells. Throughout this application the terms primary component carrier (PCC) and primary serving cell (PCell) are used interchangeably. Similarly, the terms secondary component carrier (SCC) or secondary serving cell (SCell) are used interchangeably.

For carrier aggregation when Channel State Information (CSI) reports for multiple carriers collide in time, only one CQI is reported while the CSI for other carriers are dropped. A priority based on CSI mode/type determines which CSI shall be reported.

For CSI may include Channel Quality Indicator/Precoding Matrix Indicator/Rank Indicator (CQI/PMI/RI). In CQI/PMI/RI feedback in down link (DL) carrier aggregation (CA), the reporting parameters periodicity and offset can be independently configured for each CC. Then collision of CSI reports form different CCs can be usually avoided by reasonable eNB implementation. For cases where collision does happen such as eNB mis-configuration, the following handling procedures were proposed:

Uplink control information (UCI) transmission on Physical Uplink Control CHannel (PUCCH) and Physical Uplink Shared CHannel (PUSCH) for carrier aggregation (CA) was discussed at the 3GPP RAN1 working group. For periodic UCI (PMI/CQI/RI) transmitted on PUCCH it was agreed that:

(1) For periodic CQI/PMI/RI reporting for CA, at least configuration of different (in time) PUCCH resources for reports for each CC is supported.

(2) If simultaneous PUCCH and PUSCH is configured and there is at least one PUSCH transmission on a serving cell then: if there is a collision between CSI and Hybrid Automatic Repeat Request Acknowledge (HARQ-ACK) in the same subframe, the HARQ-ACK is transmitted on PUCCH white the periodic CSI is transmitted on PUSCH; all UCI mapped onto PUSCH in a given subframe are mapped onto a single serving irrespective of the number of serving cells transmitting PUSCH on this subframe.

The current standard agreement supports independent configuration of the RI/PMI/CQI reporting parameters per DL CC including subframe offset, periodicity and reporting mode. The eNB is left to configure the UCI periodicity/offset such that RI/PMI/CQI reports of different CCs does not collide in the time domain. This is possible because carrier aggregation is mostly applicable for low-mobility user equipment (UE) with good channel condition. Thus the channel variation is slow and a large RI/CQI/PMI periodicity suffices. In the event of a collision of CSI reports of two CCs there are two basic options. The first option supports a larger CSI payload format. The second option prioritizes a CSI type and/or CC by combining/dropping reports from different CCs and/or CSI types based on a pre-defined priority order.

The PUCCH is an extremely narrow pipeline with limited in feedback capacity, CSI accuracy and granularity. It is beneficial not to increase the CSI reporting scenarios in order to minimize testing complexity. The impact of the dual-codebook structure on PUCCH CSI feedback should be considered. The following discusses the CSI feedback when a UE is configured for DL CA considering the PUCCH limitations.

The dual-stage codebook structure has been adopted for the eight antenna ports(8 Tx) case. Each precoding matrix is the multiplication of two component matrices, given by W=W₁×W₂, where W₁ is a wideband precoding matrix that is constant across the system bandwidth, and W₂ is a narrow-band precoding matrix that may vary on different frequency band. Two CSI modes are defined in Long Term Evolution (LTE) Rel. 10 for 8 Tx feedback on PUCCH. In submode 1 first precoding matrix/second precoding matrix (W₂/W₂) are reported in different subframes. In submode 2 W1/W2 are reported in the same subframe. It is preferable to have the same CSI modes configured on different DL CCs. This simplifies the timing relationship between RI/CQI/PMI first precoding matrix (W₁) and second precoding matrix (W₂) report.

The currently adopted standard does not concatenate Rank Indicator (RI) bits across different CCs into one PUCCH. RI bits of each CC are multiplexed in different subframes by configuring different PUCCH offsets and/or periodicities. This ensures the reliability of RI/W₂ feedback for ≧3 bits which significantly impacts the subsequent PMI/CQI report. The maximum RI payload per PUCCH should be equivalent to one DL CC. The exact payload of RI per CC should depend on the outcome of the PUCCH CSI mode discussion.

For RI and CQI/PMI, the RI of a first CC and the PMI/CQI of a second CC should not be reported together in the same PUCCH so as to jeopardize the reliability of RI report. Likewise the eNB implementation should configure the feedback offsets and periodicities (N_{OFFSET,RI,} and N_{OFFSET,CQI}) of each CC intelligently. The following exemplary embodiments for UE procedure are given for when the RI of a first CC and CQI/PMI of a second CC occurs.

When the RI of CC n and the PMI/CQI of CC m collides, CQI/PMI should be dropped or reported in PUSCH. When dropping is considered, use this order of priority: RI; wideband CQI/PMI; and subband CQI. Thus if RI of CC n collides with PMI/CQI of CC m, PMI/CQI is dropped. If wideband PMI/CQI of CC n collides with subband PMI of CC m, subband PMI is dropped. The CSI of the SCell may always be dropped when CSI of PCell collides with CSI of SCell. Alternatively all CSI can be piggy-backed in PUSCH in case collision occurs. This PUSCH transmission may be triggered with an explicit UL grant, or semi-statically configured by higher layer without an UL grant, such as triggered by the event of CSI collision between different CC. In this case PUSCH is preferably scheduled on PCC.

For the LTE Rel. 8/9 standard if a collision occurs between CQI/PMI/RI and Hybrid Automatic Repeat Request-Acknowledge (HARQ-ACK) transmission, the CQI/PMI/RI is dropped. This may lead to frequent dropping of CSI reports in the LTE Rel. 10 standard because all HARQ-ACK feedback from all DL CCs is sent on the PUCCH of the UL PCC. Increasing the payload size or increasing the modulation to accommodate the CSI on PUSCH is not recommended because: this increases link budget requirements; and such new modulation or payload size does not scale for LTE Rel. 10 control signaling since support of up to 5 DL CCs is mandated for LTE Rel. 10.

An alternative to avoid frequent dropping of CSI transmits periodic CSI on the PUSCH. When a UE is not configured for simultaneous PUCCH and PUSCH the CSI can only be transmitted when the UE is allocated an UL grant. Otherwise, the CSI is dropped. When the UE is configured for simultaneous PUCCH and PUSCH, one technique to avoid dropping of CSI is to transmit acknowledge/not acknowledge (ACK/NAK) on PUCCH and CSI on PUSCH.

For periodic CQI/PMI/RI feedback in DL carrier aggregation, the reporting parameters of periodicity and offset can be independently configured for each CC. Thus collision of CSI reports of different CCs can be usually avoided by reasonable eNB implementation. When collisions do happen such as due to eNB mis-configuration), the following handling procedures were adopted.

For periodic CQI/PMI/RI reporting, the set of higher-layer configuration parameters as defined in LTE Rel. 8 are independently configured for each DL component carrier.

When simultaneous PUCCH and PUSCH is not configured, periodic CQI/PMI/RI is reported for only one DL component carrier (CC) in one subframe on PUCCH. The DL CC is determined according to a priority: prioritize between CCs based on CSI (CQI/PMI/RI) reporting mode/type; if the reporting mode/type is the same, prioritize by Radio Resource Control (RRC) configured priority between CCs; the same priority rule applies to both the case without PUSCH and the case with PUSCH. The CQI/PMI/RI for other DL component carriers is dropped. For the determined DL CC, the same LTE Rel. 8 procedure applies for collisions between RI, wideband CQI/PMI, subband CQI for the same CC.

This application discusses the details of prioritization between different CSI reporting modes/types in case of collision between CQI/PMI/RI.

Although dropping CQI/PMI/RI based on the CSI mode/type is feasible, this leads to a quite complicated UE behavior and non-trivial standardization work. The complicating issues are: different CCs may be configured in different transmission modes and hence different CSI modes; some CSI type is associated with a corresponding CSI mode but not another; some CC may have PMI enabled while other CC have PMI disabled; different CCs configured with different number of CSI-RS ports, such as four antenna ports (4 Tx) or 8 Tx, and hence different CSI mode/type; different CCs may have the same CSI modes but different Transmit Mode (TM), such as TM 3 (CRS-based feeback) vs. TM 9 (CSI-RS based feeback).

The PUCCH report configuration is an implementation issue and collision can usually be avoided by appropriate PUCCH periodicity and offsets. Thus CQI/PMI/RI collision usually results from an erroneous network configuration case. Optimizing for this corner case is possible, but may result in little performance benefits not yet shown by system level simulation. Therefore a simpler solution that relies solely on a RRC configured priority of the CC itself is preferable.

### SUMMARY OF THE INVENTION

This application considers the need for enhancements to the baseline CSI reporting mechanisms including maximum payload size, CQI/PMI reporting configurations and CSI transmission in the event of collision between CSI reports from different CCs.

### BRIEF DESCRIPTION OF THE DRAWINGS

These and other aspects of this invention are illustrated in the drawings, in which:

FIG. 1 illustrates an exemplary prior art wireless communication system to which this application is applicable;

FIG. 2 shows the Evolved Universal Terrestrial Radio Access (E-UTRA) Time Division Duplex (TDD) frame structure of the prior art;

FIG. 3 illustrates an exemplary block diagram in wireless communication system, where CSI feedback for two component carriers are compared such that CSI is reported for the component carrier with a higher CSI priority;

FIG. 4 illustrates an exemplary CSI report selection method, wherein CSI selection is based on CSI type priority;

FIG. 5 illustrates an exemplary CSI report selection method, wherein CSI selection is based first on CSI mode priority, followed by CSI type priority;

FIG. 6 illustrates an exemplary CSI report selection method, wherein CSI selection is based on CSI group priority; and

FIG. 7 is a block diagram illustrating internal details of a base station and a mobile user equipment in the network system of FIG. 1 suitable for implementing this invention.

### DETAILED DESCRIPTION OF PREFERRED EMBODIMENTS

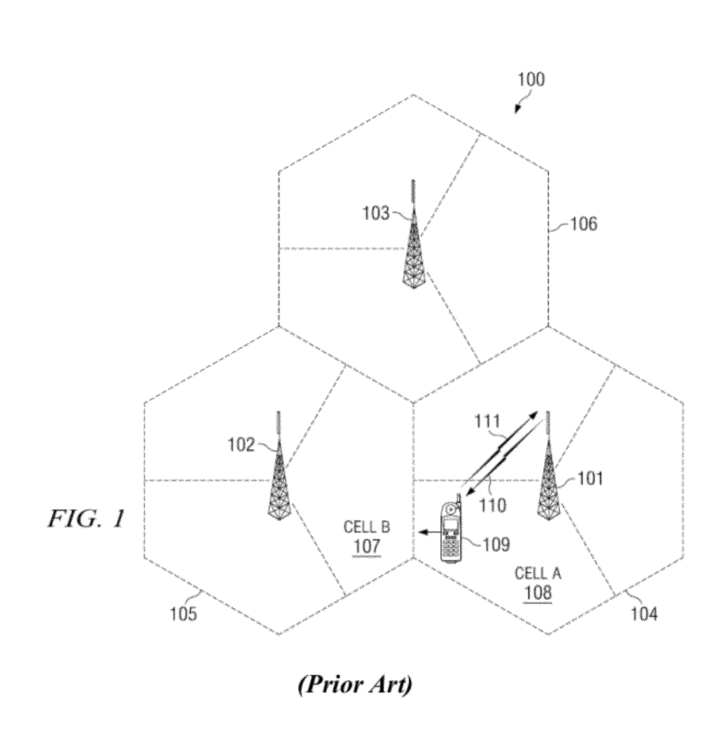

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 (eNB) are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up-link 111 time or frequency or code resources. If UE 109 has data ready for transmission, which may be traffic data, measurements report, tracking area update, UE 109 can transmit a random access signal on up-link 111. The random access signal notifies base station 101 that UE 109 requires up-link resources to transmit the UEs data. Base station 101 responds by transmitting to UE 109 via down-link 110, a message containing the parameters of the resources allocated for UE 109 up-link transmission along with a possible timing error correction. After receiving the resource allocation and a possible timing advance message transmitted on down-link 110 by base station 101, UE 109 optionally adjusts its transmit timing and transmits the data on up-link 111 employing the allotted resources during the prescribed time interval.

Base station 101 configures UE 109 for periodic uplink sounding reference signal (SRS) transmission. Base station 101 estimates uplink channel state information (CSI) from the SRS transmission.

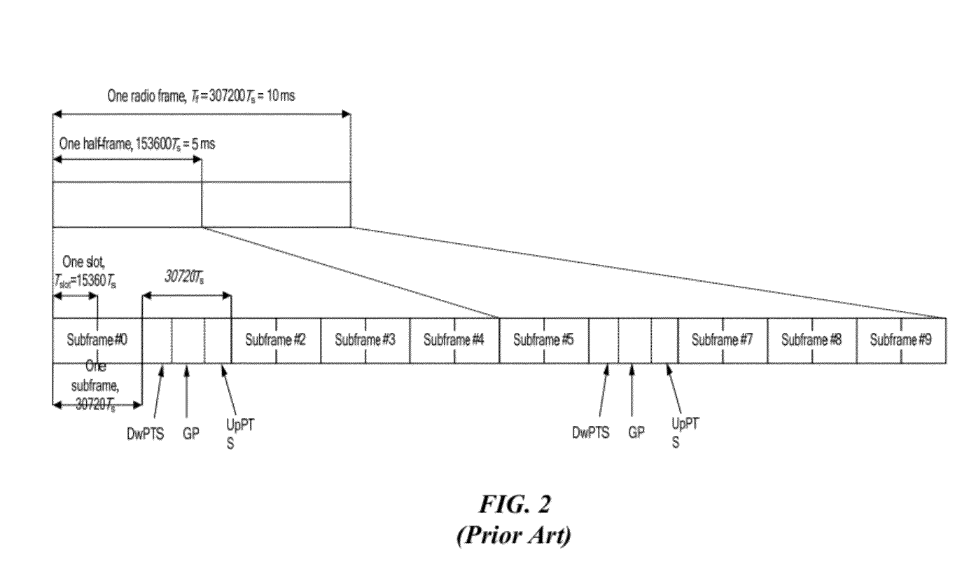

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| Config- | Switch-point | Sub-frame number | | | | | | | | | |
|---|---|---|---|---|---|---|---|---|---|---|---|
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

This invention includes preference on issues related to periodic CQI/PMI/RI transmission on PUCCH. The preferences are as follows. The system may configure a different PUCCH reporting mode (e.g. mode 1-0/1-1, 2-0/2-1) on each CC. There is no concatenation of RI of different CC on PUCCH in the same subframe. There is no concatenation of RI of a first CC and CQI/PMI of second CC on PUCCH in the same subframe. The maximum RI and CQI/PMI payload per CC depends on the outcome of PUCCH CSI mode selection. Re-use of LTE Rel. 8 Reed-Muller (RM) code occurs if the RI and PMI/CQI payload does not exceed 11-bits.

Periodic CQI/PMI/RI is reported for only one DL component carrier (CC) in one subframe on PUCCH. The selected DL CC is determined according to the priority of the downlink carriers. The PCell should have higher priority than a SCell.

Table 2 summarizes the PUCCH reporting mode/types in LTE Rel. 10 if a prioritization based on CSI mode/type is indeed necessary.

TABLE 2

| | CSI Mode | TM mode | Reporting contents | | | |
|---|---|---|---|---|---|---|
| 2 TX | 1-1 | | RI (3) | WB CQI/PMI (2) | | |
| 4 Tx | 2-1 | | RI (3) | WB CQI/PMI (2) | SB CQI (1) | |
| | 1-0 | TM 4/8/9 | | WB CQI (4) | | |
| | | TM 3 | RI (3) | WB CQI (4) | | |
| | 2-0 | TM 4/8/9 | | WB CQI (4) | SB CQI (1) | |
| | | TM 3 | RI (3) | WB CQI (4) | SB CQI (1) | |
| 8 Tx | 1-1, sub-mode 1 | | RI/W1(5) | WB W2/CQI (2b) | | |
| | 1-1, sub-mode 2 | | RI (3) | WB W1/W2/CQI | | |
| | | | | (2c) | | |
| | 2-1 | | RI/PTI (6) | WB W1 (2a) | WB W2/CQI (2b) | SB W2/CQI (1a) |
| | 1-0 | | | WB CQI (4) | | |
| | 2-0 | | | WB CQI (4) | SB CQI (1) | |

There are two reports that have the same CSI mode but different CSI type. The same prioritization principles in LTE Rel. 8 can be re-used especially for 2/4 Tx antenna configuration. For 8 Tx a similar principle is applied for PUCCH mode 1-1, both sub mode 1 (W1 jointly encoded with RI) and sub mode 2 (W1 jointly encoded with W2/CQI).

If different CC are configured with the same CSI mode, then for 2/4 Tx, RI (3) has a higher priority than wideband PMI/CQI (2), which has a higher priority than wideband CQI (4), which has a higher priority than sub band CQI (1). For 8 Tx and PUCCH mode 1-1 sub mode 1, then RI/W1(5) has a higher priority than W2/CQI (2b). For 8 Tx and PUCCH mode 1-1, sub mode 2, then RI (3) has a higher priority than W1/W2/CQI (2c).

For 8 Tx PUCCH mode 2-1, the introduction of Precoding Type Indicator (PTI) bit requires additional prioritization rule. The PUCCH 2-1 feedback structure is as follows. Report 1 is RI and 1-bit precoding type indication (PTI). Report 2, when PTI=0 wideband W1 will be reported and when PTI=1 wideband CQI and wideband W2 will be reported. Report 3, when PTI=0 wideband CQI and wideband W2 will be reported and when PTI=1 subband CQI and subband W2 will be reported.

RI/PTI should be given the highest priority as it determines the reporting structure of W1/W2/CQI. Wideband W1 alone (following PTI=0) should be given the second highest priority, because W1 has a lower effective reporting periodicity than W2/CQI and should be protected to avoid PUCCH ambiguity in case of a lost W1 report.

For 8 Tx PUCCH mode 2-1, priority is given as RI/PTI (6) has a higher priority than wideband W1 (2a) which has a higher priority than wideband CQI/W2 (2b) which has a higher priority than subband CQI/W2 (1a).

In case two CSI reports are associated with different CSI modes, there are two possible cases. The first case has different CSI modes and the same CSI type. The second case has different CSI mode and different CSI types. It is possible to tabulate the priority order for all mode and type combination. Since there is a large number of possible combinations stemming from 7 modes and 10 types, this is unnecessarily complicated. In addition, no performance gain has been shown requiring such a practice.

A simpler alternative determines the priority order based on the reporting modes and drops the lower priority. If the reporting modes are identical, this simplifies alternative drops the CQI/PMI/RI based on the CSI type.

This alternative prioritizes the PUCCH report on the following principles. First, this alternative decides based on CSI mode priority. The CQI/PMI/RI of a lower priority reporting mode is dropped. Second, this alternative decides based on CSI type priority. The CQI/PMI/RI of a lower priority reporting type is dropped.

Prioritization may depend on whether PMI feedback is included. With independent PMI configuration per CC either due to different transmission mode or due to PMI enabling/disabling, one CC may have the PMI report enabled while another CC has its PMI feedback disabled. RI/PMI feedback constitutes an important feedback component for downlink beamforming and should be preserved whenever possible. Because CQI is derived based on PMI once PMI is dropped due to collision, then the ensuing CSI report loses its reference and becomes less useful.

In another embodiment of this invention the CQI/PMI/RI report for a CC with PMI enabled is prioritized over CQI/PMI/RI report for another CC with PMI disabled. Therefore PUCCH mode 1-1/2-1 is prioritized over mode 1-0/2-0. PUCCH mode 1-0 is prioritized over mode 2-0. PUCCH mode 1-1 is prioritized over mode 2-1.

For 8 Tx PUCCH mode 1-1, sub mode 1 (W1 jointly encoded with RI) and sub mode 2 (W1 jointly encoded with W2/CQI) are possible. Due to the 8 Tx codebook size (max 4-bit W1, max 4-bit W2, max 7-bit CQI), joint encoding of W1 and W2/CQI incurs significant codebook sub-sampling to accommodate the 11-bit PUCCH payload. This reduces the CQI feedback accuracy and DL throughput. To avoid heavy codebook sub-sampling, it is preferable to prioritize sub mode 1 to maintain higher feedback accuracy.

For 8 Tx, PUCCH mode 1-1 sub mode 1 is prioritized over sub mode 2. If RI/W1 (sub-mode 1) collides with RI (sub-mode 2), RI is dropped. If W2/CQI (sub-mode 1) collides with PMI/CQI (sub-mode 2), PMI/CQI is dropped.

Even if the CSI mode and type are completely identical, a number of issues may also affect the reporting priority. The UE configured in transmission mode 9 (TM9) in LTE Rel. 10 performs channel measurement based on CSI-RS. A UE-specific CSI-RS configuration has been proposed for the standard. If UE-specific CSI-RS is adopted, the standard should further clarify whether or not the UE-specific CSI-RS configuration shall be CC-common or CC-specific. Note UE-specific L1 parameters, such as transmission mode, CQI/PMI/RI reporting configuration, are usually assumed configurable on a CC-specific basis.

Whether or not CSI-RS can be configured CC-specific basis needs to be clarified if UE-specific CSI-RS configuration is adopted.

If number of CSI-RS antenna ports configuration is CC-specific, a higher priority is preferable for a CC with a larger number of CSI-RS antenna ports. This generally requires more spatial resolution and feedback accuracy.

The CQI/PMI/RI report for 1 2/4/8 CSI-RS antenna ports shall be allocated with an increasing priority order.

One possibility is to prioritize the CSI report entirely on CSI type, and independent of the CSI mode. The 7 CSI reporting type can be categorized into three groups, where different groups have different priority. CSI in a lower-priority group is dropped if collided with another CSI report in a higher priority group.

This invention proposes the following CSI grouping: Group 1 is RI (and its variant), including RI (Type 3), RI/W1 (Type 5), RI/PTI (Type 6); Group 2 is wideband CQI/PMI (and its variant), including Wideband CQI/PMI (Type 2), CQI (Type 4), W1 (Type 2a), W2/CQI (Type 2b), W1/W2/CQI (2c); and Group 3 is subband CQI/PMI, including Subband CQI (Type 1), subband W2/CQI (Type 1a). The inter-group prioritization is group 1 has a higher priority than group 2 which has a higher priority than group 3. If two colliding CSI reports belong to the same group, further prioritization is performed and a lower priority report is dropped.

In another embodiment, Group 1 includes RI (Type 3), RI/W1 (Type 5), RI/PTI (Type 6), and wideband W1 (Type 2a); Group 2 is wideband CQI/PMI (and its variant), including Wideband CQI/PMI (Type 2), CQI (Type 4), W2/CQI (Type 2b), W1/W2/CQI (Type 2c); and Group 3 is subband CQI/PMI, including Subband CQI (Type 1), subband W2/CQI (Type 1a). The inter-group prioritization is group 1 has a higher priority than group 2 which has a higher priority than group 3. If two colliding CSI reports belong to the same group, further prioritization is performed and a lower priority report is dropped.

This invention proposed the following intra-group prioritization. For Group 1: in a first alternative RI/W1 (5) has a higher priority than RI (3) which has a higher priority than RI/PTI (6); in a second alternative RI (3) has a higher priority than RI/W1 (5) which has a higher priority than RI/PTI (6). For Group 2: in a first alternative W2/CQI (2b) has a higher priority than W1/W2/CQI (2c) which has a higher priority than W1(2a) which has a higher priority than CQI/PMI (2) which has a higher priority than CQI (4); in a second alternative W1/W2/CQI (2c) has a priority higher than W2/CQI (2b) which has a higher priority than W1(2a) which has a higher priority than CQI/PMI (2) which has a higher priority than CQI (4). For Group 3, subband W2/CQI (1a) has a higher priority than subband CQI (1).

In another embodiment, if two colliding CSI reports belong to the same priority group, CSI of the DL component carrier with a larger component carrier index is dropped.

In another embodiment, if two CSI reports are of the same type but are associated with different reporting modes, further prioritization based on CSI mode can be considered, for example based on rules above.

This application concerns the CSI mode/type prioritization order for PUCCH report in DL CC. The following principles are proposed.

The CQI/PMI/RI report for 1 2/4/8 CSI-RS antenna ports shall be allocated with an increasing priority order. If the CSI modes are not identical, then for 2/4 Tx: PUCCH mode 1-1/2-1 is prioritized over mode 1-0/2-0; PUCCH mode 1-0 is prioritized over mode 2-0; and PUCCH mode 1-1 is prioritized over mode 2-1. For 8 Tx PUCCH mode 1-1 sub-mode 1 is prioritized over sub-mode 2. If the CSI mode are identical then for 2/4 Tx: RI (3) is prioritized over wideband PMI/CQI (2) is prioritized over wideband CQI (4) is prioritized over sub band CQI (1). For 8 Tx; for PUCCH mode 1-1, sub-mode 1 RI/W1(5) is prioritized over W2/CQI (2b); for PUCCH mode 1-1, sub-mode 2 RI (3) is prioritized over W1/W2/CQI (2c); and for PUCCH mode 2-1 RI/PTI (6) is prioritized over wideband W1 (2a) is prioritized over wideband CQI/W2 (2b) is prioritized over subband CQI/W2 (1a).

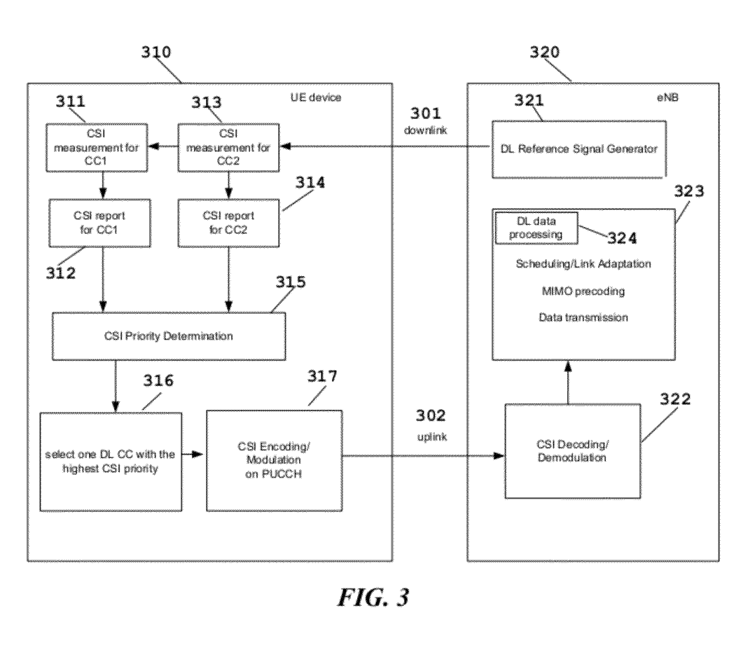

FIG. 3 is an operations flow diagram illustrating a wireless communication system where CSI feedback for two component carriers are compared an CSI is reported for the component carrier with a higher CSI priority. FIG. 3 illustrates user equipment (UE) 310 and base station (eNB) 320. Within eNB 320 DL Reference Signal Generator 321 generates a reference signal which is supplied to UE 310 via downlink 301.

Within UE 310 the reference signal supplies CSI measurement for CC1 block 311 and CSI measurement for CC2 block 313. CSI measurement for CC1 block 311 measures the reference signal as applied to CC1 and supplies CSI report for CC1 block 312. Likewise measurement for CC2 block 313 measures the reference signal as applied to CC2 and supplies CSI report for CC2 block 314. Both CSI report blocks 312 and 314 supply reports to CSI priority determination block 315. CSI priority determination block 315 supplies the determined priorities to block 316. Block 316 selects one of the DL CC having the highest priority. Block 316 supplies this selected DL CC to CSI encoding block 317. CSI encoding block 317 encodes the selected response to the DL reference signal on PUCCH. This radio frequency signal is supplied to eNB 320 via uplink 302.

CSI decoding/demodulation block 322 of eNB 320 decodes and demodulates the signal from uplink 302. The decoded and demodulate signal is supplied to block 323. Block 323 provides various functions such as: scheduling link adaptation; multiple input, multiple output (MIMO) precoding; and data transmission. Block 323 includes block 324 for DL data processing.

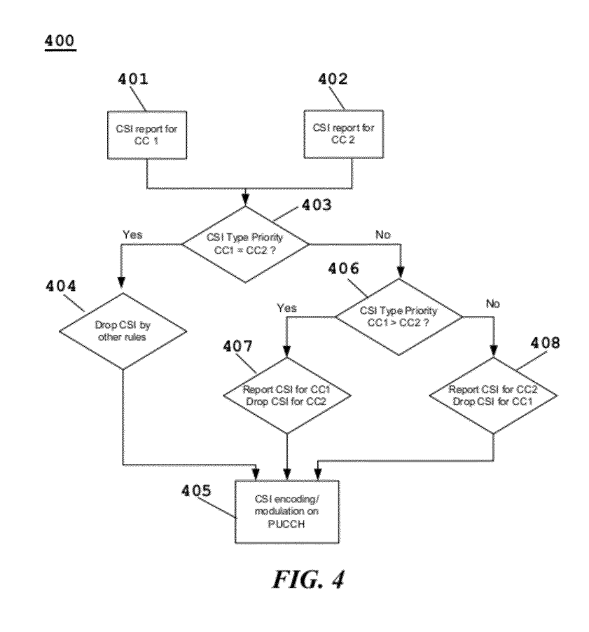

FIG. 4 is a flow chart 400 of an exemplary CSI report selection method where CSI selection is based on CSI type priority. Flow chart 400 receives inputs for CSI CC1 at block 401 and CSI CC2 at block 402.

Test block 403 receives both input and determines if the CSI type priority of CC1 equals the CSI type priority of CC2. If this is true (Yes at test block 403), then block 404 determines the relative priority of CC1 and CC2 by other rules. Following priority determination in block 404, block 405 encodes and modulates the selected CC on PUCCH.

If the CSI type priority of CC1 does not equal that of CC2 (No at test block 403), then test block 406 determines if the CSI type priority of CC1 is greater than the CSI priority of CC2. If this is true (Yes at text block 406), then block 407 selects CC1 for CSI and drops CC2. Block 405 encodes and modulates CC1 on PUCCH. If this is not true (No at text block 406), then block 408 selects CC2 for CSI and drops CC1. Block 405 encodes and modulates CC2 on PUCCH.

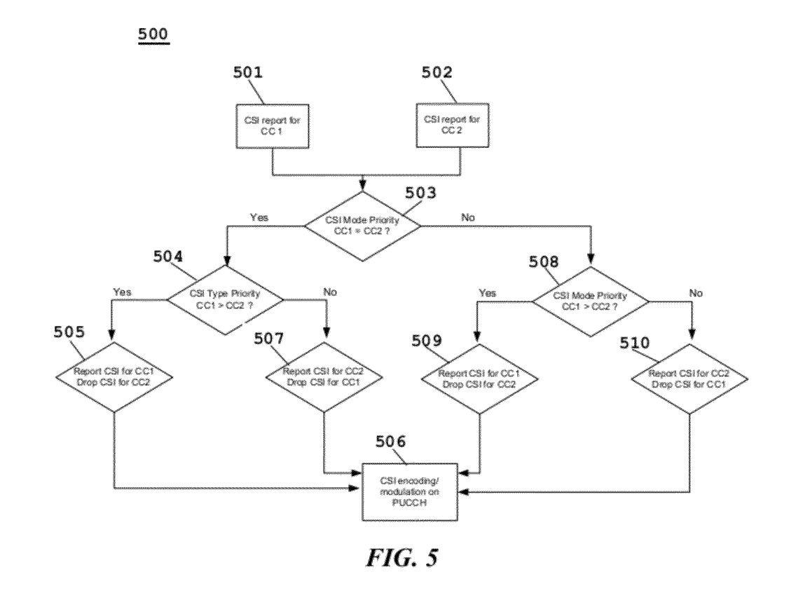

FIG. 5 is a flow chart 500 of an exemplary CSI report selection method where CSI selection is based first on CSI mode priority followed by CSI type priority. Flow chart 500 receives inputs for CSI CC1 at block 501 and CSI CC2 at block 502.

Test block 503 receives both input and determines if the CSI mode priority of CC1 equals the CSI mode priority of CC2. If this is true (Yes at test block 503), then test block 504 determines if the CSI type priority of CC1 is greater than that of CC2. If this is true (Yes at test block 504) then block 505 selects CC1 for CSI and drops CC2. Following priority determination in block 505, block 506 encodes and modulates CC1 on PUCCH.

If the CSI type priority of CC1 is not greater than that of CC2 (No at test block 504) then block 507 selects CC2 for CSI and drops CC1. Following priority determination in block 507, block 506 encodes and modulates CC2 on PUCCH.

If the CSI mode priority of CC1 does not equal that of CC2 (No at test block 503), then test block 508 determines if the CSI mode priority of CC1 is greater than the CSI mode priority of CC2. If this is true (Yes at text block 508), then block 509 selects CC1 for CSI and drops CC2. Block 506 encodes and modulates CC1 on PUCCH. If this is not true (No at test block 508), then block 510 selects CC2 for CSI and drops CC1. Block 506 encodes and modulates CC2 on PUCCH.

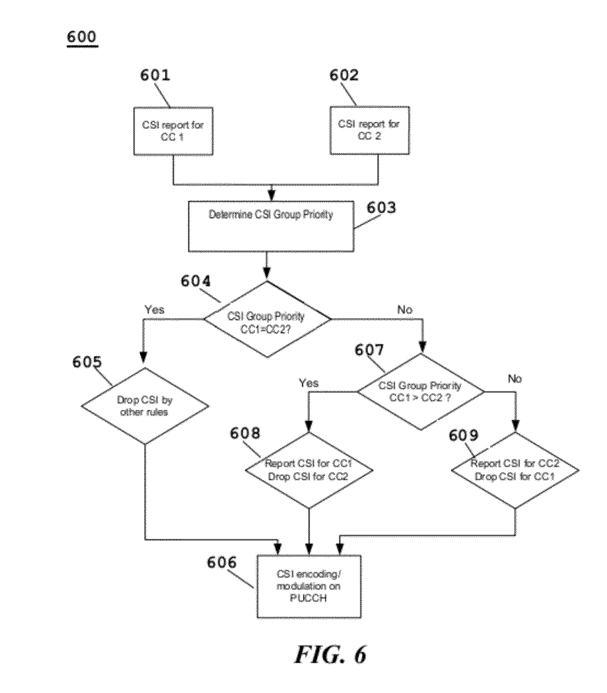

FIG. 6 is a flow chart 600 of an exemplary CSI report selection method where CSI selection is based on CSI group priority. Flow chart 600 receives inputs for CSI CC1 at block 601 and CSI CC2 at block 602. Block 603 determines the CSI priority group

Test block 604 receives the determined CSI group for the two inputs and determines if the CSI group priority of CC1 equals the CSI group priority of CC2. If this is true (Yes at test block 604), then block 605 determines the relative priority of CC1 and CC2 by other rules. Following priority determination in block 605, block 606 encodes and modulates the selected CC on PUCCH.

If the CSI group priority of CC1 does not equal that of CC2 (No at test block 604), then test block 607 determines if the CSI group priority of CC1 is greater than the CSI group priority of CC2. If this is true (Yes at text block (608), then block 608 selects CC1 for CSI and drops CC2. Block 606 encodes and modulates CC1 on PUCCH. If this is not true (No at text block 607), then block 609 selects CC2 for CSI and drops CC1. Block 606 encodes and modulates CC2 on PUCCH.

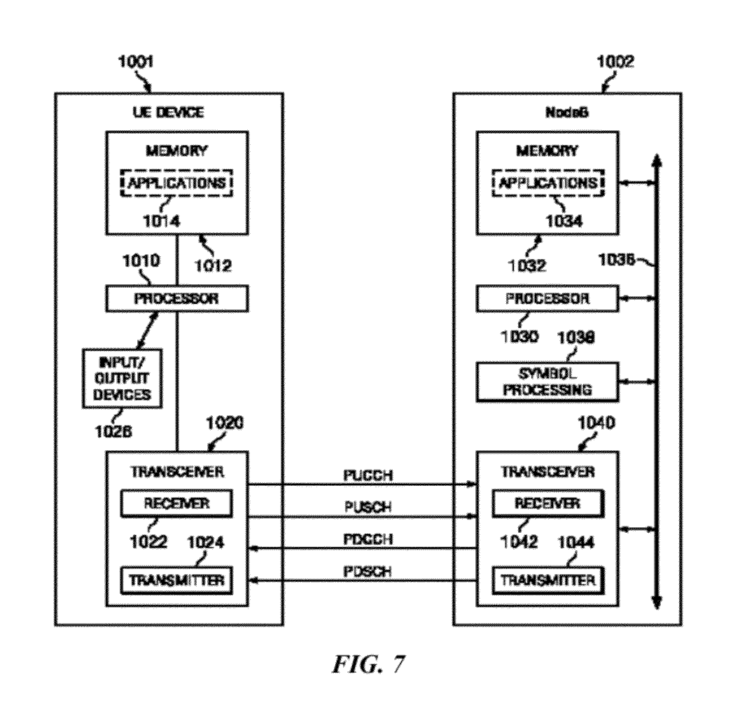

FIG. 7 is a block diagram illustrating internal details of an eNB 1002 and a mobile UE 1001 in the network system of FIG. 1. Mobile UE 1001 may represent any of a variety of devices such as a server, a desktop computer, a laptop computer, a cellular phone, a Personal Digital Assistant (PDA), a smart phone or other electronic devices. In some embodiments, the electronic mobile UE 1001 communicates with eNB 1002 based on a LTE or Evolved Universal Terrestrial Radio Access Network (E-UTRAN) protocol. Alternatively, another communication protocol now known or later developed can be used.

Mobile UE 1001 comprises a processor 1010 coupled to a memory 1012 and a transceiver 1020. The memory 1012 stores (software) applications 1014 for execution by the processor 1010. The applications could comprise any known or future application useful for individuals or organizations. These applications could be categorized as operating systems (OS), device drivers, databases, multimedia tools, presentation tools, Internet browsers, emailers, Voice-Over-Internet Protocol (VOIP) tools, file browsers, firewalls, instant messaging, finance tools, games, word processors or other categories. Regardless of the exact nature of the applications, at least some of the applications may direct the mobile UE 1001 to transmit UL signals to eNB (base-station) 1002 periodically or continuously via the transceiver 1020. In at least some embodiments, the mobile UE 1001 identifies a Quality of Service (QoS) requirement when requesting an uplink resource from eNB 1002. In some cases, the QoS requirement may be implicitly derived by eNB 1002 from the type of traffic supported by the mobile UE 1001. As an example, VOIP and gaming applications often involve low-latency uplink (UL) transmissions while High Throughput (HTP)/Hypertext Transmission Protocol (HTTP) traffic can involve high-latency uplink transmissions.

Transceiver 1020 includes uplink logic which may be implemented by execution of instructions that control the operation of the transceiver. Some of these instructions may be stored in memory 1012 and executed when needed by processor 1010. As would be understood by one of skill in the art, the components of the uplink logic may involve the physical (PHY) layer and/or the Media Access Control (MAC) layer of the transceiver 1020. Transceiver 1020 includes one or more receivers 1022 and one or more transmitters 1024.

Processor 1010 may send or receive data to various input/output devices 1026. A subscriber identity module (SIM) card stores and retrieves information used for making calls via the cellular system. A Bluetooth baseband unit may be provided for wireless connection to a microphone and headset for sending and receiving voice data. Processor 1010 may send information to a display unit for interaction with a user of mobile UE 1001 during a call process. The display may also display pictures received from the network, from a local camera, or from other sources such as a Universal Serial Bus (USB) connector. Processor 1010 may also send a video stream to the display that is received from various sources such as the cellular network via RF transceiver 1020 or the camera.

During transmission and reception of voice data or other application data, transmitter 1024 may be or become non-synchronized with its serving eNB. In this case, it sends a random access signal. As part of this procedure, it determines a preferred size for the next data transmission, referred to as a message, by using a power threshold value provided by the serving eNB, as described in more detail above. In this embodiment, the message preferred size determination is embodied by executing instructions stored in memory 1012 by processor 1010. In other embodiments, the message size determination may be embodied by a separate processor/memory unit, by a hardwired state machine, or by other types of control logic, for example.

eNB 1002 comprises a Processor 1030 coupled to a memory 1032, symbol processing circuitry 1038, and a transceiver 1040 via backplane bus 1036. The memory stores applications 1034 for execution by processor 1030. The applications could comprise any known or future application useful for managing wireless communications. At least some of the applications 1034 may direct eNB 1002 to manage transmissions to or from mobile UE 1001.

Transceiver 1040 comprises an uplink Resource Manager, which enables eNB 1002 to selectively allocate uplink Physical Uplink Shared CHannel (PUSCH) resources to mobile UE 1001. As would be understood by one of skill in the art, the components of the uplink resource manager may involve the physical (PHY) layer and/or the Media Access Control (MAC) layer of the transceiver 1040. Transceiver 1040 includes at least one receiver 1042 for receiving transmissions from various UEs within range of eNB 1002 and at least one transmitter 1044 for transmitting data and control information to the various UEs within range of eNB 1002.

The uplink resource manager executes instructions that control the operation of transceiver 1040. Some of these instructions may be located in memory 1032 and executed when needed on processor 1030. The resource manager controls the transmission resources allocated to each UE 1001 served by eNB 1002 and broadcasts control information via the PDCCH.

Symbol processing circuitry 1038 performs demodulation using known techniques. Random access signals are demodulated in symbol processing circuitry 1038.

During transmission and reception of voice data or other application data, receiver 1042 may receive a random access signal from a UE 1001. The random access signal is encoded to request a message size that is preferred by UE 1001. UE 1001 determines the preferred message size by using a message threshold provided by eNB 1002. In this embodiment, the message threshold calculation is embodied by executing instructions stored in memory 1032 by processor 1030. In other embodiments, the threshold calculation may be embodied by a separate processor/memory unit, by a hardwired state machine, or by other types of control logic, for example. Alternatively, in some networks the message threshold is a fixed value that may be stored in memory 1032, for example. In response to receiving the message size request, eNB 1002 schedules an appropriate set of resources and notifies UE 1001 with a resource grant.

What is claimed is:

1. A method of wireless telephony comprising the steps of:
periodic uplink transmission from a mobile user equipment to a base station of channel state information (CSI) including channel quality indicator/precoding matrix indicator/rank indicator on a physical uplink control channel (PUCCH) using the same physical uplink control channel (PUCCH) channel state information (CSI) reporting modes for all downlink serving cells.

2. The method of claim 1, wherein:
the same physical uplink control channel (PUCCH) channel state information (CSI) reporting mode is not used for each downlink serving cell.

3. The method of claim 1, wherein:
the rank indicator of a first downlink serving cell is not concatenated with the rank indicator of a different serving cell on the physical uplink control channel (PUCCH) in the same subframe.

4. The method of claim 1, wherein:
the rank indicator of a first serving cell and is not concatenated with the channel quality indicator and the precoding matrix indicator of a second serving on the physical uplink control channel (PUCCH) in the same subframe.

5. The method of claim 1, wherein:
a maximum rank indicator and channel quality indicator/precoding matrix indicator payload per serving cell depends on the physical uplink control channel (PUCCH) channel state information mode selection.

6. The method of claim 5, further comprising:
re-using LTE Rel. 8 RM code if the rank indicator and precoding matrix indicator/channel quality indicator payload does not exceed 11 bits.

7. The method of claim 1, further comprising:
prioritizing channel state information (CSI) reports having the same channel state information (CSI) mode but different channel state information (CSI) types, where a first channel state information (CSI) report of a serving cell with lower priority is dropped when colliding with a second channel state information (CSI) report of a serving cell with higher priority.

8. The method of claim 7, wherein:
said step of prioritizing reports for 2 or 4 antenna ports gives rank indicator (Type 3) a higher priority than wideband precoding matrix indicator/channel quality indicator (Type 2), which has a higher priority than wideband channel quality indicator (Type 4), which has a higher priority than sub band channel quality indicator (Type 1).

9. The method of claim 7, wherein:
said step of prioritizing reports for 8 antenna ports and physical uplink control channel (PUCCH) mode 1-1, sub mode 1 gives rank indicator/wideband precoding matrix (W1) (Type 5) has a higher priority than wideband precoding matrix (W1)/narrow-band precoding matrix (W2)/channel quality indicator (Type 2b).

10. The method of claim 7, wherein:
said step of prioritizing reports for 8 antenna ports and physical uplink control channel mode 1-1, sub mode 2 gives rank indicator (Type 3) a higher priority than wideband precoding matrix (W1)/narrow-band precoding matrix (W2)/channel quality indicator (Type 2c).

11. The method of claim 7, wherein:
said step of prioritizing reports for 8 antenna ports and physical uplink control channel (PUCCH) mode 2-1 and a Precoding Type Indicator (PTI) bit gives rank indicator/Precoding Type Indicator (PTI) (Type 6) a higher priority than wideband precoding matrix (W1) (Type 2a) which has a higher priority than wideband channel quality indicator/narrow-band precoding matrix (W2) (Type 2b) which has a higher priority than subband channel quality indicator/narrow-band precoding matrix (W2) (Type 1a).

12. The method of claim 1, further comprising:
prioritizing reports having the different channel quality indicator modes and the same channel quality indicator type.

13. The method of claim 1, wherein:
said step of prioritizing reports
prioritizes based upon channel quality indicator mode if the channel quality indicator modes differ, and
prioritizes based upon channel quality indicator type if channel quality indicator modes are the same.

14. The method of claim 1, wherein:
said step of prioritizing reports prioritizes a channel quality/precoding matrix indicator/rank indicator report for a serving cell with precoding matrix indicator enabled over a channel quality/precoding matrix indicator/rank indicator report for a serving cell with precoding matrix indicator disabled.

15. The method of claim 1, further comprising:
prioritizing CSI reports based on grouping of CSI reporting types, where different groups have different priority, and
a first CSI report of a lower priority group is dropped when colliding with a second CSI report of a higher priority group.

16. The method of claim 15, wherein
a CSI priority group 1 includes rank indicator (type 3), RI/W1 (type 5), RI/PTI (type 6);
a CSI priority group 2 includes wideband CQI/PMI (type 2), CQI (type 4), W1(type 2a), W2/CQI (type 2b), W1/W2/CQI (type 2c);
a CSI priority group 3 includes subband CQI (type 1), subband W2/CQI (type 1a); and
CSI report group 1 has a higher priority than group 2 which has a higher priority than group 3.
